(19) United States
(12) Patent Application Publication
(10) Pub. No.: US 2021/0067355 A1
(43) Pub. Date: Mar. 4, 2021

(54) POWER OVER ETHERNET LOCAL DATA PROCESSING

(71) Applicant: SIGNIFY HOLDING B.V., EINDHOVEN (NL)

(72) Inventors: Harald Josef Günther RADERMACHER, EINDHOVEN (NL); Matthias WENDT, EINDHOVEN (NL)

(21) Appl. No.: 16/962,010

(22) PCT Filed: Jan. 8, 2019
(86) PCT No.: PCT/EP2019/050321

§ 371 Date: Jul. 14, 2020

(30) Foreign Application Priority Data
Jan. 16, 2018 (EP) 18151890.3

(51) Int. Cl. H04L 12/10; H04B 3/02; H05B 47/185; H05B 45/10; H05B 45/20

(52) U.S. Cl. CPC H04L 12/10; H04B 3/02; H05B 45/20; H05B 45/10; H05B 47/185

(57) ABSTRACT

The present invention relates to a data processing device (10′) for a power over Ethernet system (100). The data processing device (10′) comprises a data communicating unit (12) and a data processing unit (14). The data communicating unit (12) is configured for establishing a first connection (30) to a power sourcing equipment (24) and a second connection (32) to a powered device (26) and for intercepting central data transmitted from the power sourcing equipment (24) to the powered device (26). The data processing unit (14) is configured to process the intercepted central data in dependence of local data received from a local powered device (16). The local data comprises user input data, sensing data, or user input data and sensing data. The data communicating unit (12) is furthermore configured for transmitting the processed data to the powered device (26). Hence local data can influence central data for improving local control.

### FIELD OF THE INVENTION

The present invention relates to a data processing device, a system, a method for processing data, and a computer program. In particular the invention relates to a data processing device for a power over Ethernet system, a power over Ethernet system, and a method for processing data in a power over Ethernet system.

### BACKGROUND OF THE INVENTION

Power over Ethernet is described in the IEEE 802.3af standard, Power over Ethernet plus is described in the IEEE 802.3at standard, and 4 Pair Power over Ethernet is currently developed in the IEEE Task Force P802.3bt which will lead to the upcoming IEEE 802.3bt standard. Data is communicated via the Ethernet Protocol between devices in power over Ethernet systems. Therefore a microchip in form of an Ethernet controller such as ENC28J60 can be used to establish a communication link between the devices. The microchip ENC28J60 for example is an Ethernet Controller with on board Media Access Control (MAC) and physical layer (PHY) of the Open Systems Interconnection model (OSI model).

WO 2017/030530 A1 shows an in-line device with a data module, a power over Ethernet module, a Bluetooth low energy module, and a management module. The in-line device can be connected to an Ethernet switch with power sourcing equipment capability and a powered device. The management module can coordinate and translate power request information as well as power availability information. The management module may intercept, generate and modify Ethernet packets exchanged between the Ethernet switch and the powered device.

EP2701338A1 discloses a Power over Ethernet (PoE) system which includes a solar module (2) comprising at least one photovoltaic cell for generating DC power, DC power management means (7) connected to the solar module (2), and a PoE network (12) connected to the DC power management means (7) to deliver DC power to one or more light fixtures (14a, 14b, 14c). A power injection system (8) and central PoE control switch (10) can assist in controlling the distribution of DC power as well as managing data connections in the PoE network (12).

### SUMMARY OF THE INVENTION

It can be seen as an object of the present invention to provide a data processing device, a power over Ethernet system, a method for processing data, and a computer program which allow improved local control.

In a first aspect of the present invention a data processing device for a power over Ethernet system is presented. The data processing device comprises a data communicating unit, and a data processing unit. The data communicating unit is configured for establishing a first connection to a power sourcing equipment (PSE) and a second connection to a powered device (PD). The data communicating unit is furthermore configured for intercepting central data transmitted from the PSE to the PD. The data processing unit is configured to process the intercepted central data in dependence of local data received from a local PD. The data communicating unit is furthermore configured for transmitting the processed data to the PD. The local data comprises user input data, sensing data, or user input data and sensing data.

Since the data processing device comprises a data communicating unit that is configured for intercepting central data transmitted from the PSE to the PD and a data processing unit that is configured to process the intercepted data in dependence of local data received from a local PD, which comprises user input data, sensing data, or user input data and sensing data, it is possible to improve the local control of the PDs and the power over Ethernet system. In particular the local data allows modifying central data, such that for example a local control is possible.

Power over Ethernet in this text is understood as covering all embodiments of power over Ethernet, e.g., power over Ethernet according to IEEE 802.3af standard, power over Ethernet plus according to IEEE 802.3at standard, 4 pair power over Ethernet according to the upcoming IEEE 802.3bt standard or any other power over Ethernet.

The data communicating unit can comprise one or more ports for establishing connections via Ethernet connections. Each of the ports can comprise one or more pins. A pin can be configured for receiving power, data or power and data. Additionally or alternatively the port can also comprise one or more solar cell units for receiving power in the form of photons. Therefore the ports can be configured for receiving power, data or power and data. The ports can be configured to connect the data processing device with the PSE and/or the PD via an Ethernet connection. As the ports can receive power and data via the Ethernet connection some of the pins can be supplied with power, while other pins are supplied with data via the Ethernet connection. Alternatively or additionally a pin can also be supplied with power and data via the Ethernet connection.

An Ethernet connection can for example be an optical fiber, an electric wire or a twisted pair cable, such as a Cat 3 cable, Cat 4 cable, Cat 5 cable, Cat 5e cable, Cat 6 cable, Cat 6A cable, Cat 7 cable, Cat 7A cable, Cat 8 cable, Cat 8.1 cable, or Cat 8.2 cable. The Ethernet connection can have several pairs of cables, e.g., 2, 3, 4, or more pairs of cables. The cables can be unshielded or shielded, in particular individually, overally or individually and overally shielded. The power and data can be transmitted via the same fiber, wire, or cable of the Ethernet connection or via different fibers, wires, or cables of the Ethernet connection. In case of transmission of power via an optical fiber the power can be transmitted in the form of photons that can be received by a solar cell unit of the data receiving device.

The data processing device can comprise the local PD or the data communicating unit can be configured for establishing a third connection to the local PD, e.g., comprising a third port for establishing a connection via an Ethernet connection. The local PD can be a user interface device that provides user input data to the data processing device, a sensor device that provides sensing data to the data processing device or a user interface and sensor device that provides user input data and sensing data to the data processing device. The user interface device can for example comprise a potentiometer, a switch, a switch panel, a dimmer, a rotary dimmer, or a touch display. The sensor device can for example comprise a temperature sensor, a movement sensor, a brightness sensor or any other sensor. The data processing device can also comprise two or more local PDs or it can also be connected to two or more local PDs, such as a user interface device and/or a sensor device. The data processing device can also be connected to two or more PDs.

In one embodiment the data processing unit is configured to determine the processed data by calculating a function depending on central data and local data. The processed data can for example be determined by multiplying the central data and the local data, i.e. processed_data=central_data local_data. The processed data can be the minimum of the central data and the local data, i.e., processed_data=min(central_data,local_data) or the maximum of the central data and the local data, i.e. processed_data=max(central_data,local_data). The processed data can also be zero, i.e., the central data that is intercepted is factually blocked, as the processed data in this case for example corresponds to a zero voltage. Therefore the local data can for example comprise a value of zero and the function can for example be a multiplication of the central data and the local data or selecting the minimum of them. In this situation the PD cannot be controlled by the central data and the current configuration of the PD is maintained even if central data is transmitted from the PSE to the PD. Alternatively the PD can be configured to perform a predetermined mode if no processed data is received by the PD, e.g., a standby mode.

The data processing unit can also for example be configured to determine the processed data by two or more functions in order to process multiple parameters. For a PD in the form of a lighting device comprising a light-emitting diode (LED) array, the central data can for example be control parameters for adjusting brightness and correlated color temperature (CCT) of the lighting device. The local data can be a local configuration setting manually inserted by a user of a local PD in form of a user interface device, such as a touch display. The value of the local data can for example be between 0 and 1. The local data can also be a value between 0 and 2. In this case for example the processed data for the brightness can be determined as a multiplication of the value of the central data and the value of the local data. Furthermore the processed data for the CCT can for example be determined with processed_data_CCT=2000K+local_data*4500K. Hence in this case two parameters can be controlled in dependence of the local data. The value of the local data can also be any other value which in a function allows at least partly to control a parameter.

The data communicating unit can be configured for transmitting data received from the PD to the PSE. The data can for example comprise a power request of the PD. The data in form of the power request can hence be forwarded to the PSE if the data processing device requires only a low amount of power.

Alternatively the data communicating unit can be configured for intercepting data transmitted between the PD and the PSE. In this case the data processing unit can process the intercepted data in order to modify the power request such that the power requirement of the data processing device is added to the power request of the PD. The data communicating unit can then transmit the processed data in form of the power request of both the PD and the data processing device to the PSE.

In one embodiment the data processing device comprises a simple logic unit. The simple logic unit can be configured for encoding data in a characteristic of one or more data packets, decoding data encoded in a characteristic of one or more data packets, and/or processing data encoded in a characteristic of one or more data packets. Hence the simple logic unit can be configured for encoding data in a characteristic of one or more data packets, decoding data encoded in a characteristic of one or more data packets or processing data encoded in a characteristic of one or more data packets. The simple logic unit can also be configured for any combination of encoding data in a characteristic of one or more data packets, decoding data encoded in a characteristic of one or more data packets, and processing data encoded in a characteristic of one or more data packets. The simple logic unit can also be part of the data communicating unit or data processing unit. The data communicating unit and the data processing unit can alternatively or additionally each comprise a simple logic unit. The data processing device can also comprise two or more simple logic units.

The characteristic can comprise data packet length, data packet duration, number of data packets in a predetermined time interval, and/or sequence of data packets. Hence the characteristic can comprise data packet length, data packet duration, number of data packets in a predetermined time interval, or sequence of data packets. The characteristic can also comprise any combination of data packet length, data packet duration, number of data packets in a predetermined time interval, and sequence of data packets. Hence the data can be encoded in one or more of the characteristics of the data packet or data packets. The data packet can be an Ethernet data packet and the data packets can be Ethernet data packets. The data packet duration can for example be measured by measuring time of a voltage signal and/or counting bits or transitions.

The simple logic unit can process data without the need to be able to fully decode the MAC or higher layers of the OSI model. Since the simple logic unit is configured to encode data in a characteristic of one or more data packets it is possible to transmit data from the data processing device without the need to be able to fully encode a MAC or higher layers of the OSI model. This allows reducing power consumption and costs as effort in driver software can be reduced and no micro chip (μC) or micro processor (μP) is required for processing data in the data processing device and the power over Ethernet system. Instead the data processing device only requires a simple logic unit. The simple logic unit can have a PHY. In case that the simple logic unit does not have a PHY the power consumption and cost can be reduced even further.

The simple logic unit can comprise a switch, a logic gate, a comparator, a timer, and/or a counter. Hence the simple logic unit can comprise a switch, a logic gate, a comparator, a timer, or a counter. The simple logic unit can also comprise any combination of a switch, a logic gate, a comparator, a timer, and a counter. The simple logic unit can also comprise any combination of switches, logic gates, comparators, timers and counters. The counter can be a digital counter, such as a simple logic integrated circuit (IC) or a complementary metal-oxide-semiconductor (CMOS) decade counter. The counter can for example be configured to count a number of data packets received per time interval. The counter can alternatively for example be configured to count a number of data packets and to reset the timer after counting a predetermined number of data packets. The timer can for example be configured to measure a time interval and to reset the counter after the time interval has lapsed. The comparator can be configured for detecting voltages corresponding to presence of data.

The simple logic unit can furthermore comprise a simple timer-based switch for generating processed data as a pulse width modulation of the central data based on the local data. The simple timer-based switch can for example be opened and closed based on the local data.

The simple logic unit can also comprise analogue circuitry or a simple μC. In this case the simple μC can be configured to execute simple logic functions on the encoded data and the respective decoded data. The simple μC is, however, not configured for processing the data stored in the data packet or data packets itself. The simple μC is a low cost and low power consumption μC, i.e., with power consumption below a few mW, e.g., below 10 mW, below 5 mW, below 2 mW, or below 1 mW. The μC can be configured to run simple programs.

The simple logic unit can be configured for processing the intercepted central data in dependence of the local data by reducing the length, duration and/or number of data packets of the central data. Hence the simple logic unit can be configured for processing the intercepted central data in dependence of the local data by reducing the length, duration or number of the central data. The simple logic unit can also be configured for processing the intercepted central data in dependence of the local data by a combination of reducing the length, duration and number of the central data.

The data can be encoded in a pulse-density modulation. The data can therefore for example be encoded in a pulse density-modulation using data packet duration, amount of data packets, and/or length of data packets. The data can for example be encoded in an amount of data packets received in a predetermined time interval, e.g., 20, 8, or 0 data packets received for example in a time interval of 200 ms, 100 ms, 50 ms, or 10 ms. The data packets can have a predetermined length resulting in a predetermined duration. Averaging over several time intervals can be used to increase resolution.

The data can also be encoded in a time for receiving a predetermined number of data packets. The predetermined number of data packets divided by the time can be used to calculate the number of data packets in a predetermined time interval.

The central data can comprise control data comprising a command for controlling the PD. The processed data can comprise control data comprising a command for controlling the PD based on the central data and the local data.

Furthermore processed data, local data, and central data can comprise control data comprising a command for controlling the PD. The local data comprising control data can be provided as user input data. The control data can for example comprise a command for adjusting the brightness or emitted color of a PD in form of a lighting device with a lamp or LED, a command for turning the PD on or off, or a command for activating or deactivating a predetermined operation mode of the PD, such as a standby mode or a predetermined color cycling mode. Alternatively or additionally the data can comprise sensing data, status data, or configuration data. Sensing data can for example be provided by a sensor, such as a brightness sensor, movement sensor, temperature sensor, or any other sensor. Status data can for example be the status of a PD as activated or deactivated or operating in a specific mode. Status data can also for example be a time a PD is running or a time in a time zone in which the PD is operating. The configuration data can for example comprise a configuration setting that can be time dependent and/or dependent on sensing data, i.e., time dependent, dependent on sensing data or depending on both time and sensing data. A configuration setting for a lighting device can for example command zero brightness during day time and 50% brightness during morning and evening and 100% brightness during night time. The configuration setting for the lighting device can furthermore depend on sensing data, e.g., applying the configuration setting only if a sensor device detects a person in proximity to the lighting device. A configuration setting for a heating device, cooling device or temperature regulating device can for example comprise no heating at night in winter and heating during daytime in winter and no heating in summer or cooling in summer The configuration setting for the heating device, cooling device or temperature regulating device can for example be based on sensing data, such as a temperature, e.g., applying heating or cooling until a predetermined temperature threshold is reached.

In one embodiment of the data processing device, the data processing unit comprises a μC. The μC can be a simple μC without a PHY, a simple μC with limited PHY, or a μC with full Ethernet Interface and full PHY. The μC with full Ethernet Interface can process data encoded with Ethernet protocol, xClip protocol, or any other protocol that requires a full Ethernet Interface. The simple μC can process data encoded in a characteristic of one or more data packets. The μC with full Ethernet Interface can be configured for identifying specific data, such as lighting related data, heating related data, control data, or any data that can be distinguished from the other data in the data packets. In particular the μC can be configured to identify control data for controlling the PD. The μC can additionally or alternatively be configured for adapting the size of a data packet, e.g., by filling the payload of the data packet with dummy data. The data packet size can for example be used to control brightness, color, and scene of the PD in form of a lighting device.

The data processing unit can be configured to process all central data or only specific data, such as lighting related data, heating related data, control data, or any data that can be distinguished from the other data.

In one embodiment some information of the data is encoded in a characteristic of one or more data packets while some information is arranged in the payload of the data packet. The rest of the payload of the data packet can be filled with dummy data. The data processing device can comprise a toggling logic unit that allows some data packets with central data to pass the data processing device without being modified, i.e., the processing is based on local data that does not modify the central data, such that processed data corresponds to central data. Other data packets with central data can be processed based on local data, such that the data packets are modified. The PD receiving these modified and unmodified data packets can use the processed data comprising the central data and local data in order to perform a function, e.g. change the brightness and CCT.

The data processing unit can also be configured to process the central data by combining the central data with local data, e.g. for CCT dimming

The local PD can for example be a local memory storing configuration settings previously inserted by a user or time dependent configuration settings, e.g., in combination with a clock or a timer that provides a time in order to provide time specific configuration setting values.

The data processing device can for example be arranged in a hotel room or office room in order to allow local control of the user besides a central control of the power over Ethernet system.

The data processing device can be a part of an Ethernet connection, such as a part of a cable that can be used to connect a PSE with a PD.

In a further aspect of the present invention a power over Ethernet system is presented. The system comprises a data processing device according to any embodiment of the present invention, a PSE, and a PD. The data processing device is daisy chained between the PSE and the PD.

The data processing device can be arranged directly between the PSE and the PD. Alternatively further PDs can be arranged between the PSE and the data processing device or the PD and the data processing device. The PSE, data processing device, and PD can be connected via Ethernet connections. The daisy chaining can be linear or for example in the form of a ring.

The PD can comprise a functional unit. The functional unit can be configured for performing a function based on the processed data. The functional unit can also be configured to perform a function based on the central data or local data. In particular the functional unit can be configured to perform a function based on control data. The functional unit can for example be a lamp, an LED, an LED array, a sensor, a magnet, an actuator, a fan, a heating unit, a cooling unit, a temperature regulating unit or any other functional unit for performing a function.

In one embodiment the PSE and/or the PD comprise a simple logic unit. Hence the PSE, the PD, or the PSE and the PD can comprise a simple logic unit. The simple logic unit can be configured for encoding data in a characteristic of one or more data packets and/or for decoding data encoded in a characteristic of one or more data packets. Hence the simple logic unit can be configured for encoding data in a characteristic of one or more data packets, decoding data encoded in a characteristic of one or more data packets, or encoding data in a characteristic of one or more data packets and decoding data encoded in a characteristic of one or more data packets. The system can be configured for transmitting the encoded data between the PSE and the PD. The PSE can therefore for example receive encoded data from PDs or the PDs can receive encoded data from the PSE. Such data can for example be control data, status data, configuration data, or sensing data.

Since the data is encoded in a characteristic of one or more data packets, the information stored in the data packets, i.e., in the bit patterns, can be dummy information. Alternatively the data and the characteristic of the data packet or data packets can be used in order to transmit information.

The PD can be a lighting device, a user interface device, a sensor device, a magnet device, an actuator device, a fan device, a heating device, a cooling device, or a temperature regulating device. The lighting device can for example comprise a lamp, LED array, or LED as functional unit. The user interface device can for example comprise a potentiometer, a switch, a switch panel, a dimmer, a rotary dimmer, or a touch display.

The PSE can be connected to a building management system (BMS), server, or central controller. The PSE can receive central data, e.g. stored in data packets from the BMS, the server or the central controller. The server can for example be controlled via a mobile phone, desktop personal computer (PC), lap top PC, tablet PC or the like in order to allow a central control of the system. The central data can be received by the PSE for example via Ethernet connection using the Ethernet Protocol. In this case the PSE decodes data received via the Ethernet protocol, determines the MAC address and encodes the data in a characteristic of one or more data packets using the simple logic unit. Alternatively or additionally encoded data can be received by the PSE for forwarding the encoded data to the PD. In this case the data can for example be encoded by the BMS. The central data encoded in a characteristic of one or more data packets can be transmitted to the PD that does not require to actually decode the information stored in the data packets, but only the information encoded in the characteristic of the data packet or data packets. As the data processing device is daisy chained between the PSE and the PD the data processing device can intercept the central data and process the intercepted central data based on local data in order to transmit processed data to the PD.

The system can also comprise two or more PDs. The PSE can be configured to control the transmission of the central data to each of the PDs. The PSE can comprise a number of ports to which data processing devices or PDs can be connected for example via Ethernet connections. The PSE, data processing devices, and the PDs can be connected in a predetermined connection configuration such that the PSE is configured to transmit central data to a specific one of the PDs, e.g., by associating one or more specific ports with a MAC address of a PD. The predetermined connection configuration can for example be produced in a configuration step when the data processing device, PDs, and PSE are connected via Ethernet connections.

The PSE can be configured to measure a power consumption of the PDs of the system. The PSE can also be configured to control the transmission of the data packets to each of the PDs based on the measured power consumption of each of the PDs. The PSE can for example be configured to transmit data encoded in the data packet or data packets only to PD that have a simple logic unit for decoding the encoded data, e.g. indicated by a predetermined power consumption, such as a power consumption below a predetermined threshold, for example below a few mW, e.g., below 10 mW, below 5 mW, below 2 mW, or below 1 mW. In this case the encoded data can be sent to all of the PDs with predetermined power consumption, to a specific one of the PDs or to a specific group of PDs, comprising two or more PDs. The power consumption of a PD can thus be used to identify PDs that have the ability to decode data encoded in a characteristic of one or more data packets.

The PSE, and the data processing device can also be configured to transmit central data, local data and/or processed data to a specific PD, a group of PDs or all PDs.

In one embodiment the PD comprises an energy storage. The energy storage is configured to supply power to the PD. The energy storage can for example be configured to supply power to the PD during a standby mode or modes in which no power is received via the Ethernet connection. The PD can be configured to perform a standby mode in order to reduce power consumption. The standby mode can for example be automatically activated if no power is transmitted via the Ethernet connection, for example if the system is turned into a standby mode to reduce power consumption. In the standby mode power consumption and functionality of the PD is reduced. Furthermore the power transmission to the PD via the Ethernet connection can be blocked. In this case the PD is powered by the energy storage alone. Complex circuitry, such as μC and μP with PHY that consume power in the range of several hundreds of mW are unsuitable for operating based on stand alone energy storages. Since the simple logic unit consumes below a few mW, e.g., below 10 mW, below 5 mW, below 2 mW, or below 1 mW, it can be operated in standby mode by the power supplied by the energy storage alone without the need of power supply via the Ethernet connection. The energy storage can for example be a battery or a capacitor.

In a further aspect of the present invention a method for processing data in a power over Ethernet system is presented. The method comprises the steps:
intercepting central data transmitted from a PSE to a PD,
receiving local data from a local PD, wherein the local data comprises user input data, sensing data, or user input data and sensing data,
processing the intercepted central data in dependence of the local data, and
transmitting the processed data to the PD.

In the method for processing data, such as central data, local data, and processed data, the data can be encoded in a characteristic of one or more data packets. The characteristic can comprise data packet length, data packet duration, number of data packets in a predetermined time interval, and/or sequence of data packets. In one embodiment of the method data transmitted between the PSE and the PD is encoded in a characteristic of one or more data packets.

The step of intercepting central data can for example comprise capturing and counting data packets. The step of processing the intercepted central data can for example comprise comparing the number of data packets of the central data to the local data, and generating processed data by generating a signal, such as a pulse width modulated signal adapted to control the opening and closing of a simple switch. Hence the number of data packets of the central data can be reduced if the central data is transmitted along a line comprising the controlled simple switch in an open state. In a closed state the simple switch allows transmission of the data packets. Therefore the processed data is generated by reducing the number of data packets of the central data transmitted to the PD. The signal can be transmitted to the simple switch for closing or opening it based on the comparison result. In one embodiment the method can be a method for locally controlling a PD in a power over Ethernet system comprising the steps:
intercepting central control data transmitted from a PSE to a PD,
receiving local data from a local PD, wherein the local data comprises user input data, sensing data, or user input data and sensing data,
processing the intercepted central control data in dependence of the local data, and
transmitting the processed control data to the PD.

In a further aspect of the present invention a computer program for processing data in a power over Ethernet system is presented. The computer program comprises program code means for causing a processor to carry out the method as defined in claim 14, when the computer program is run on the processor.

In other embodiments the computer program can comprise program code means for causing a processor to carry out the method of any embodiment of the method.

Other embodiments of the computer program can comprise program code means for causing a simple logic unit to carry out the method as defined in claim 14 or any embodiment of the method, when the computer program is run on the simple logic unit.

It shall be understood that the data processing device of claim 1, the power over Ethernet system of claim 10, the method of claim 14 and the computer program of claim 15, have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically and exemplarily a first embodiment of a data processing device,

FIG. 2 shows schematically and exemplarily a first embodiment of a power over Ethernet system with a second embodiment of the data processing device,

FIG. 3 shows schematically and exemplarily a third embodiment of the data processing device in a second embodiment of the power over Ethernet system,

FIG. 4 shows schematically and exemplarily a third embodiment of the power over Ethernet system with several data processing devices and PDs,

FIG. 5 shows schematically and exemplarily a fourth embodiment of the data processing device in a fourth embodiment of the power over Ethernet system,

FIG. 6A shows central data encoded in a number of data packets,

FIG. 6B shows local data encoded in a duration of a data packet,

FIG. 6C shows processed data encoded in a number of data packets,

FIG. 7A shows central data in a payload of a data packet,

FIG. 7B shows local data encoded in a duration of a data packet,

FIG. 7C shows processed data,

FIG. 8 shows schematically and exemplarily a fifth embodiment of the data processing device in a fifth embodiment of the power over Ethernet system,

FIG. 9 shows a first embodiment of a method for processing data in a power over Ethernet system,

FIG. 10 shows a second embodiment of a method for processing data in a power over Ethernet system.

### DETAILED DESCRIPTION OF EMBODIMENTS

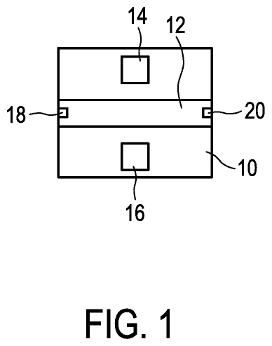

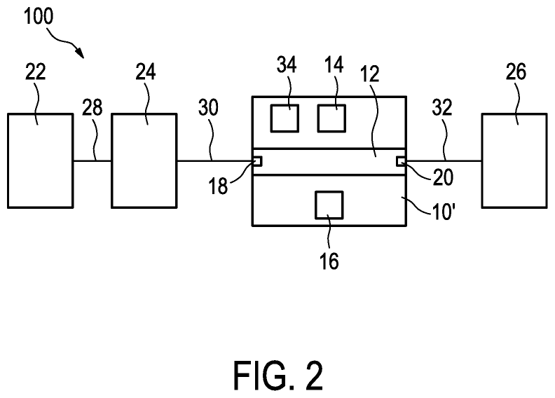

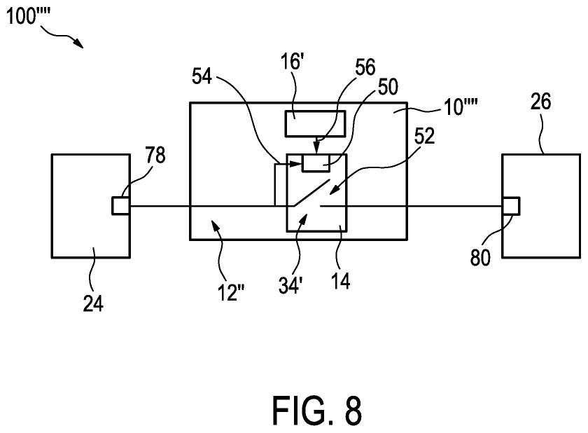

FIG. 1 shows schematically and exemplarily a first embodiment of the data processing device 10. The data processing device 10 is for a power over Ethernet system, such as one of the systems 100, 100′, 100″, 100′″, 10″″ presented in FIG. 2 to FIG. 5, and FIG. 8.

The data processing device 10 comprises a data communicating unit 12, a data processing unit 14, and a local PD in form of a user interface device, which in this embodiment is a potentiometer 16.

The data communicating unit 12 comprises ports 18 and 20 for connecting the data processing device 10 with a PSE and a PD via Ethernet connections in form of cables (not shown). Hence the data processing device 10 can be daisy chained between the PSE and the PD in order for allowing the data communicating unit 12 to intercept data transmitted between the PSE and the PD.

In this embodiment the data processing device 10 is configured to be connected to a PD in form of a lighting device with an LED array as a functional unit (not shown). The PSE in this embodiment transmits central data in form of control data in order to control the lighting device via the Ethernet Protocol. The control data therefore comprises a command for controlling the lighting device which in this embodiment is a command for adjusting the brightness to a predetermined value. The data transmitted from the PSE to the lighting device is intercepted by the data communicating unit 12. The data communicating unit 12 identifies the portions of data relevant for controlling the lighting device, i.e., in this embodiment the central data, and provides only this portion of data to the data processing unit 14 in order to process the central data. Alternatively the data communicating unit 12 can also provide the whole data to the data processing unit 14.

The data processing unit 14 additionally receives local data from the potentiometer 16. The potentiometer 16 is controlled by a user that uses it to provide his user input data. The local data can in this case be a value between 0 and 1. In other embodiments local data can be more complex information, e.g., a configuration setting with various parameter values or ranges of parameter values. In this embodiment the local data corresponds to user input data. In other embodiments the local data can for example also be sensing data or user input data and sensing data.

The data processing unit 14 processes the intercepted central data in dependence of the local data in order to generate processed data. In this embodiment the processed data comprises control data comprising a command for controlling the lighting device based on the central data and the local data. The data processing unit 14 in this embodiment therefore determines the processed data by calculating a function depending on the central data and the local data. In this embodiment the intercepted central data is multiplied with the local data, i.e. processed_data=central_data local_data in order to determine a brightness value. In other embodiments the processed data can also for example be generated by determining the minimum of the central data and the local data, i.e., processed_data=min(central_data,local_data) or the maximum of the central data and the local data, i.e. processed_data=max(central_data,local_data). In yet another embodiment the processed data can also be zero, i.e., the central data is factually blocked, as the processed data in this case for example corresponds to zero. In yet a further embodiment the PD receiving the processed data can be configured to perform a predetermined mode if no processed data is received, i.e., a zero voltage, for example activating or deactivating a PD in form of a lighting device. Such predetermined modes can also for example comprise fully activating or deactivating the lighting device, setting the brightness of the lighting device to a predetermined level, such as 10% or 100%, or setting CCT to a predetermined level, such as 2700 K, 4000 K, or 6000 K. In a further embodiment the data processing unit 14 can process the central data in order to influence multiple control parameters, for example brightness and CCT. Such processing can for example be based on two functions, such as processed_data_brightness=central_data_brightness local_data_brightness and processed_data_CCT=2000K+local_data_CCT*4500K. In yet another embodiment the local data can also override the central data, such that only local data controls the lighting device or the central data can be combined with the local data in order to allow features such as CCT dimming

The data communicating unit 12 then transmits the processed data to the lighting device via the port 18 or 20, to which the lighting device is connected. This allows local brightness control of the lighting device, as the central data transmitted from the PSE to the lighting device comprises a brightness value that is intercepted by the data processing device 10 and manipulated in dependence of the user input data. Therefore the lighting device can partly be controlled via the PSE and in addition it can be locally controlled by the potentiometer 16 of the data processing device 10.

In other embodiments local control can also be based on sensing data, such as temperature sensing data, brightness sensing data, decibel sensing data, or movement sensing data. In yet other embodiments local control can be based on user input data and sensing data.

In this embodiment the data communicating unit 12 is furthermore configured to intercept data transmitted from the lighting device to the PSE. Hence the data communicating unit 12 intercepts data transmitted between the lighting device and the PSE. In particular power requests transmitted from the lighting device to the PSE can be intercepted by the data communicating unit 12. The data communicating unit 12 provides the intercepted data to the data processing unit 14. The data processing unit 14 adds the power requirement of the data processing device 10 to the power request of the lighting device and the data communicating unit 12 transmits the processed power request to the PSE. The PSE then supplies the requested amount of power to the data processing device 10 and the lighting device via Ethernet connections in form of the cables (not shown).

In other embodiments of the data processing device 10 that have a negligible power consumption, the data communicating unit 12 can also be configured to forward the power request of the lighting device to the PSE or the data processing unit 14 can be configured for leaving the power request unmodified. In yet other embodiments the data communicating unit 12 can also only intercept data transmitted from the PSE to any PD.

In an autoclass power over Ethernet system the power requirement of the data processing device 10 and the lighting device will be recognized as a combined load by the PSE. In order to allow automatic classification of PDs in the power over Ethernet system by the PSE the functionality of the data processing device 10, i.e., the data intercepting and data processing may be temporarily deactivated in order to determine a maximal load.

FIG. 2 shows schematically and exemplarily a first embodiment of the power over Ethernet system 100. The system 100 comprises a BMS 22, a PSE 24, a second embodiment of the data processing device 10′, and a PD in form of a lighting device 26. In other embodiments of the power over Ethernet system the PD can also be any other kind of PD, such as a user interface device, a sensor device, a magnet device, an actuator device, a fan device, a heating device, a cooling device, or a temperature regulating device. The BMS 22 can also be replaced by a central controller or server (not shown).

The BMS 22, the PSE 24, the data processing device 10′, and the lighting device 26 are connected via Ethernet connections in form of cables 28, 30 and 32.

The second embodiment of the data processing device 10′ is similar to the first embodiment of the data processing device 10. The second embodiment of the data processing device 10′, however, comprises an additional simple logic unit 34. The simple logic unit 34 allows encoding data in a characteristic of one or more data packets. The simple logic unit 34 in this embodiment therefore has a simple μC with switches, logic gates, comparators, timers and counters. The characteristic can for example be data packet length, data packet duration, number of data packets in a predetermined time interval, and/or sequence of data packets.

The encoded data can be transmitted to the lighting device 26 via port 20 of the data communicating unit 12 and cable 32. The lighting device 26 comprises a simple logic unit for decoding the data encoded in a characteristic of one or more data packets (not shown). In this embodiment the simple logic unit of the lighting device comprises a RX data detector, a comparator in form of a Schmitt trigger, a counter, and a timer. The simple logic unit receives data in form of voltage signals. A voltage signal is received and detected at the RX data detector. The Schmitt trigger compares the measured voltage to a reference voltage close to a default level of the line, which in this embodiment is 0 V. Hence the Schmitt trigger can detect data packets and forward the rising edge at the start of each data packet to the counter. The counter increases by one for each data packet it receives. The timer measures time intervals and resets the counter in predetermined time intervals. The counter transmits the number of data packets counted in a time interval to a lighting device driver. The lighting device driver operates an LED array of the lighting device according to the received data, i.e., the number supplied from the counter.

In another embodiment the simple logic unit can be integrated in a simple μC that runs a program code to capture and count the data packets while resetting the counting in predetermined time intervals. The simple μC is a low cost and low power consumption μC. The simple μC can then provide a control parameter generated from the counting of the data packets to the lighting device driver.

This allows using a simple data transfer protocol between the data processing device 10′ and the lighting device 26 instead of the Ethernet protocol. As simple logic units only require a small amount of power, the power consumption of the data processing device 10′ and lighting device 26 can be reduced compared to devices communicating via Ethernet protocol.

In another embodiment the data processing device comprises simple logic units as part of the data communicating unit for decoding encoded data and encoding data in a characteristic of one or more data packets. In yet another embodiment the data processing device can comprise a simple logic unit as part of the data processing unit for processing data encoded in a characteristic of one or more data packets.

The data can be encoded in a pulse-density modulation by the simple logic unit 34 using an amount of data packets per time interval. In this embodiment brightness control data is encoded. An amount of data packets received in a predetermined time interval, e.g., 10, 3, or 0 data packets received for example in a time interval of 100 ms corresponds to a brightness of 100%, 30%, and 0%. Any other reasonable values for the number of data packets, such as 20, 50, 100 for 100% brightness and time interval, such as 5 ms, 10 ms, 50 ms, or 200 ms can also be used. The data packets are received by the simple logic unit of the lighting device 26 that decodes the brightness value encoded in the number of data packets per time interval. Averaging over several time intervals can be used to increase resolution. The brightness of the lighting device can thus be controlled by the encoded data.

The data processing unit 14 processes the intercepted control data by adjusting the number of data packets per time interval of the central data based on the local data. This leads to a modification of the brightness based on the local data. Therefore instead of a central control by the BMS 22, local control via the potentiometer 16 is possible.

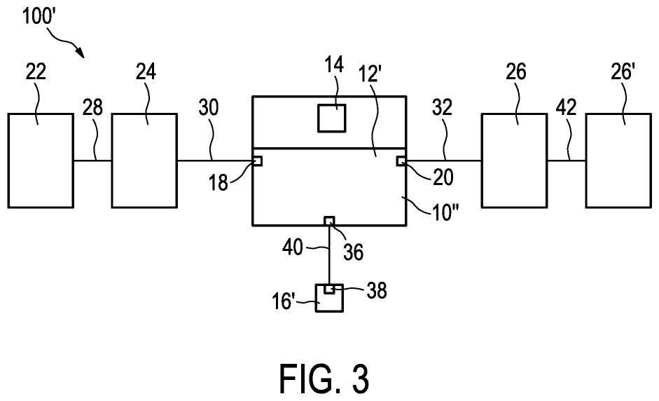

FIG. 3 shows schematically and exemplarily a second embodiment of the power over Ethernet system 100′ with a third embodiment of the data processing device 10″. The system 100′ comprises BMS 22, PSE 24, data processing device 10″, a first PD in form of a lighting device 26 and a second PD in form of a heating device 26′. The data processing device 10″ is daisy chained between the PSE 24 and the lighting device 26. The lighting device 26 is daisy chained between the data processing device 10″ and the heating device 26′.

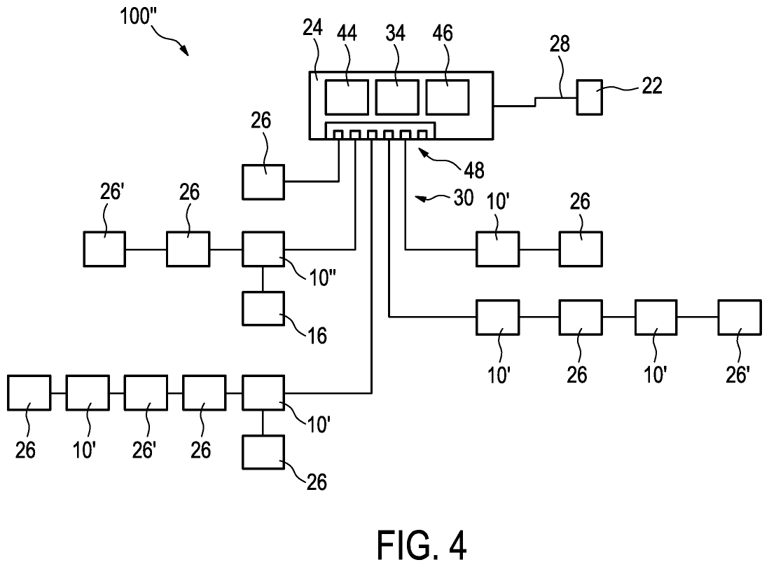

The third embodiment of the data processing device 10″ is similar to the first embodiment of the data processing device 10. The data processing device 10″, however, does not have a local PD. Instead the data communicating unit 12′ has an additional port 36 for establishing an Ethernet connection to port 38 of a local PD in form of a sensor device 16′ via cable 40. Instead of the sensor device the data processing device 10″ can also be connected to a user interface device (see FIG. 4).

The sensor device 16′ in this embodiment has a brightness sensor for obtaining brightness values in order to determine the brightness in a room in which the sensor device 16′ is arranged. Furthermore the sensor device 16′ has a temperature sensor for determining the temperature in the room. In this embodiment the sensor device 16′ is arranged in the same room as the lighting device 26 and the heating device 26′. The sensors generate sensing data which is provided to the data processing device 10″ as local data for processing intercepted central data.

The central data thus can be processed based on a brightness value and temperature value received by a sensor that is in proximity to the PDs that are to be controlled. If for example the central data would command the lighting device to adjust the brightness to an unnecessarily high brightness value, a lower brightness value in view of the brightness value derived by the brightness sensor can be determined by the data processing unit 14 in dependence of the central data and the local data. The processed data is then transmitted to the lighting device 26 that adjusts its brightness.

As the lighting device 26 is daisy chained between the data processing device 10″ and the heating device 26′, it can forward processed data to the heating device 26′ via Ethernet connection in form of cable 42. Therefore also processed data for the heating device 26′ can be transmitted from the data processing device 10″ via the daisy chained lighting device 26 to the heating device 26′. The processed data is also dependent on the sensing data obtained from the sensor device 16′, in particular on the temperature values determined by the temperature sensor.

FIG. 4 shows schematically and exemplarily a third embodiment of the power over Ethernet system 100″ with several data processing devices 10′, 10″ and PDs in form of lighting devices 26 and heating devices 26′, as well as a local PD in form of a user interface device which in this embodiment is a potentiometer 16.

The system 100″ furthermore comprises a PSE 24 with a power source 44, a simple logic unit 34, a control unit 46, and ports 48. The PSE 24 is directly connected to lighting device 26, data processing device 10″ and three data processing devices 10′ via Ethernet connections in form of cables 30 and indirectly to several more data processing devices 10′, lighting devices 26 and heating devices 26′ which are arranged in linear daisy chains. The PSE 24 is furthermore connected to BMS 22 via cable 28.

The power source 44 supplies power to the PDs, the simple logic unit 34 encodes data in a characteristic of one or more data packets and decodes data encoded in a characteristic of one or more data packets, and the control unit 46 controls the transmission of data packets. The control unit 46 can force the transmission of the data packets to each of the PDs 26 and 26′ and/or the data processing devices 10′ and 10″.

The system 100″ has various operation modes.

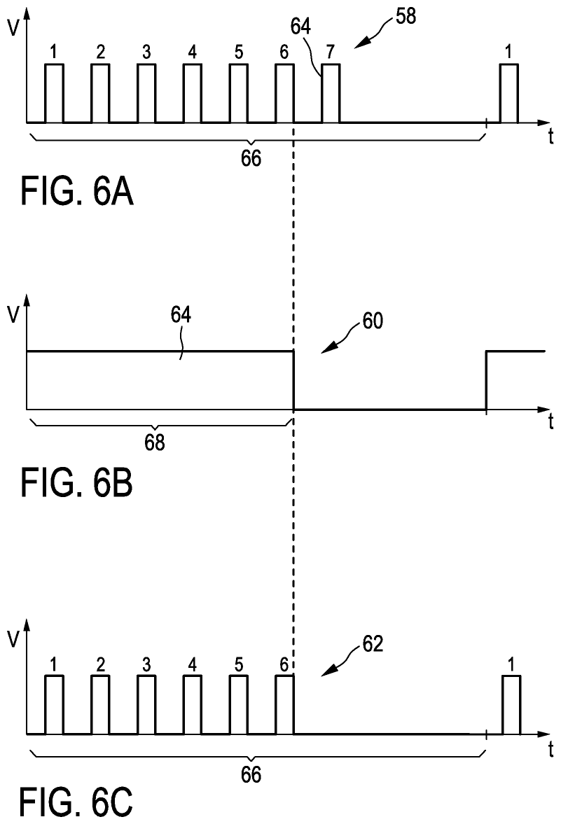

In a first operation mode central data is transmitted via cable 28 from BMS 22 to the PSE 24 using the Ethernet protocol. The central data is received by the control unit 46 which decodes the central data from the Ethernet protocol in order to identify the destination of the data packet and to identify the data stored in the data packet. The control unit 46 then transmits the data to the simple logic unit 34 for encoding the data in a characteristic of one or more data packets. The characteristic can comprise a number of data packets in a predetermined time interval (see FIG. 6A), a data packet length or a data packet duration (see FIG. 6B). In this embodiment the data is encoded in a pulse-density modulation using a number of data packets in a predetermined time interval. The simple logic unit 34 then transmits the encoded data back to the control unit 46 which transmits the encoded data to one or more of the PDs based on the identified destination of the data packet via one of the cables 30. Therefore each of the ports 48 is associated with a MAC address of one of the connected PDs. Cable 30 transmits power from the power source 44 and encoded central data from the simple logic unit 34 to the lighting device 26. A simple logic unit of the lighting device 26 decodes the central data encoded in the characteristic of the data packets. The central data comprises control data generated on or provided to the BMS 24. The control data comprises a command for controlling the lighting device 26. The control data can for example be a command to activate or deactivate one or more of the PDs or to adjust a control parameter, such as brightness, CCT, or temperature. Hence after the simple logic unit of the lighting device 26 decoded the control data it forwards the command to an LED of the lighting device 26 (not shown). The LED performs a function based on the command, e.g. it is activated or deactivated or its brightness is adjusted.

In this embodiment the five cables 30 connect the PSE 24 to five different PD arrangements. The single lighting device 26 is only controlled by central data while all other arrangements comprise at least one data processing device 10′ or 10″ which intercepts the central data and processes it based on local data in order to allow local control.

In a second operation mode data encoded in a characteristic of one or more data packets from any of the PDs can be received at the PSE 24. The data can for example be status data, configuration data, or control data. The simple logic unit 34 decodes the encoded data and the control unit 46 transmits the data to the BMS 22 via cable 28 using the Ethernet protocol.

In a third operation mode the control unit 46 measures a power consumption of the PDs. The control unit 46 can control the transmission of the data packets to each of the PDs based on the measured power consumption of each of the PDs. The control unit 46 can for example transmit encoded data only to specific PDs indicated by a predetermined power consumption, such as a power consumption below a predetermined threshold, for example below a few mW, e.g., below 10 mW, below 5 mW, below 2 mW, or below 1 mW. Considering the power consumption therefore allows the control unit 46 for example to determine whether the connected PD comprise a simple logic unit that can decode encoded data. In this case the encoded data can be sent to all of the PDs with predetermined power consumption, to a specific one of the PDs or to a specific group of PDs, comprising two or more PDs. The destination of the data can also be encoded in a characteristic of one or more data packets. As the system 100″ only comprises a limited number of devices, only a limited amount of data is needed for uniquely identifying each of the devices of the system 100″. Hence the destination can be easily encoded in a characteristic of one or more data packets.

In a fourth operation mode the system 100″ is used for remote control and status check. For example in a situation when a user has left the room in which the system 100″ is arranged and is not sure whether the lighting device 26 has been deactivated he can send a request for a status update to the BMS 22. The request can for example be send wirelessly via a mobile phone connection. The BMS 22 will then request the status update from the control unit 46 of the PSE 24 via Ethernet Protocol. The system 100″ uses a simpler protocol for the communication to the lighting device 26, such that cost and power consumption is reduced, i.e. the simple data transmission protocol. Therefore the simple logic unit 34 encodes the status request in a characteristic of one or more data packets which are provided to the lighting device 26. The simple logic unit of the lighting device 26 decodes the encoded data comprising the status request and encodes the reply to the status request, e.g., the status of the lighting device 26 as being activated or deactivated. The encoded data with the reply to the status request is transmitted to the control unit 46 which forwards it to the simple logic unit 34 for decoding and then transmits the reply to the BMS 22 which finally informs the user about the status via the mobile phone connection, e.g., by sending an e-mail. The user can then decide whether he wants to transmit control data comprising a command for activating or deactivating the lighting device 26 according to the first operation mode.

In some of the PD arrangements two data processing devices 10′ are arranged in a linear daisy chain. Hence the second data processing device 10′ arranged subsequently to a first data processing device 10′ can allow for further local control for the PDs arranged subsequently in the chain.

In one embodiment of the system the data processing unit of the data processing device can be configured to increase the control parameters of the central data (not shown).

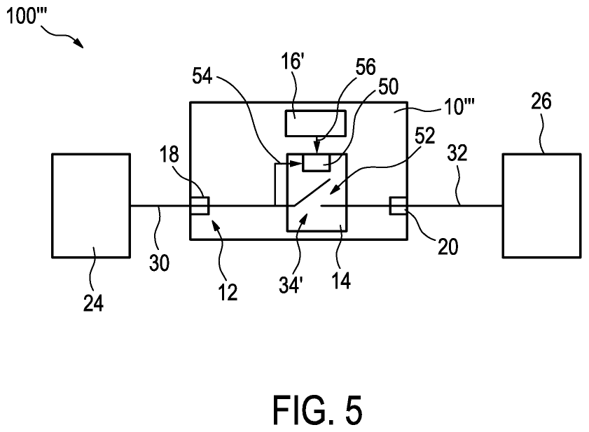

FIG. 5 shows schematically and exemplarily a fourth embodiment of the data processing device 10′″ in a fourth embodiment of the power over Ethernet system 100′″. The data processing device 10′″ is daisy chained between PSE 24 and lighting device 26.

The data processing device 10′″ comprises a data communicating unit 12, a data processing unit 14, and a local PD in form of a rotary dimmer 16′. The data communicating unit 12 comprises ports 18 and 20 for establishing Ethernet connections to the PSE 24 and the lighting device 26 via cables 30 and 32. The data processing unit 14 comprises a simple logic unit in form of a simple timer based switch 34′. The simple timer based switch 34′ comprises a timer 50 and a simple switch 52.

The PSE 24 transmits central data encoded in a characteristic of one or more data packets, in particular in a number of data packets per time interval via cable 30 to the lighting device 26. This central data is intercepted by port 18 of data communicating unit 12. The central data provides a start signal 54 for timer 50. Local data in form of user input via the rotary dimmer 16′ is provided to the timer 50 as a stop signal 56. The timer 50 generates a pulse width modulated signal based on the central data and local data.

The switch 52 is opened and closed based on the pulse width modulated signal. A higher value provided by the rotary dimmer 16′ leads to a longer relative time fraction in which the switch 52 is closed and therefore a longer time in which data packets can be transmitted from the PSE 24 to the lighting device 26 via switch 52. Hence a higher brightness value provided by the rotary dimmer 16′ leads to more data packets reaching the lighting device 26 and therefore to a higher brightness.

This embodiment of the data processing device 10′ requires only limited Ethernet functionality, in particular it does not require to be able to fully decode Ethernet data packets. In this case the data processing unit 14 can process the intercepted central data in dependence of the local data by reducing the number of data packets. Therefore the simple timer based switch 34′ is sufficient. This allows for reduced power consumption and lower system complexity.

FIG. 6A, FIG. 6B and FIG. 6C show central data 58, local data 60, and processed data 62 encoded in a characteristic of data packets 64 in graphs with voltage V on the vertical axis and time t on the horizontal axis. This embodiment regards encoded control data for controlling the brightness of a lamp of a lighting device 26 as presented in FIG. 5.

FIG. 6A shows the central data 58 encoded in a number of data packets 64. The central data 58 comprises 7 data packets in a time interval 66.

FIG. 6B shows the local data 60 encoded in a duration 68 of a data packet 64. The local data in this embodiment is used for controlling the simple switch 52 according to the embodiment of the data processing device 10′″ as presented in FIG. 5. Hence the simple switch 52 is only closed during the duration 68 of the signal representing the local data. Therefore when the switch 52 is opened the 7th data packet of the central data is not transmitted via the switch 52 to the lighting device 26. The processed data 62 therefore only comprises 6 data packets in the time interval 66 (see FIG. 6C). The switching may not be perfectly synchronized such that only part of a data packet 64 is transmitted. In this case this may lead to a quantization error. The error can be reduced by averaging over several time intervals or increasing the number of data packets, such that a stable light output of the lighting device 26 can be achieved.

In other embodiments the duration of the data packet can be used as control parameter for controlling the lighting device 26. For such cases it is noted that the Ethernet standards define a minimal and maximal data packet length, which including the preamble ranges typically between 72 to 1526 byte. Considering a predetermined network speed the length translates into a predetermined duration 68 of the data packet 64.

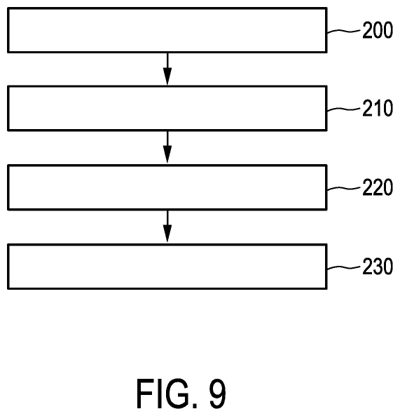

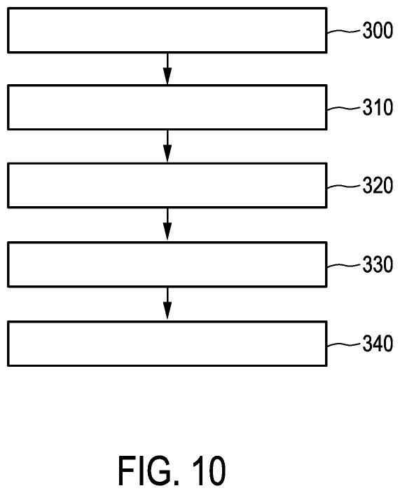

In another embodiment the number of data packets can also be counted in the data processing unit 14 (not shown). Therefore a simple logic unit can be part of the data processing unit 14 that detects the presence of a differential voltage for a duration of the minimum packet length. Based on the differential voltage start and end of the data packet can be detected. Therefore the start of the data packet is detected via presence of voltage at a RX line using a simple voltage comparator. The start signal is fed to a digital counter, which in this embodiment is a simple and low cost μC. In other embodiments simple logic ICs or CMOS decade counters can be used. The low cost μC can run a program performing a method such as the ones presented in FIG. 9 and FIG. 10 in order to control the switch 52, i.e., open and close the switch 52.

FIG. 6C shows the processed data 62 encoded in a number of data packets. The processed data 62 shown in the graph is encoded in data packets with predetermined duration. The data packets 64 are counted by a counter in the lighting device 26, which is periodically reset by a timer in time intervals 66. Hence the counter counts 6 data packets per time interval 66. The time interval 66 is 100 ms in this embodiment, but can also be any other reasonable time interval, such as 10 ms, 25 ms, 50 ms, 200 ms, or longer time intervals. In this embodiment 10 data packets in 100 ms correspond to a brightness value of 100% while 0 data packets correspond to a brightness value of 0% and each data packet corresponds to a brightness adjustment of 10%, such that 6 data packets correspond to a brightness of 60%.

In another embodiment the number of received data packets 64 per time interval 66 can be averaged for several time intervals 66 in order to improve the resolution. Alternatively the resolution can be improved by increasing the number of data packets 64 per time interval 66.

In this embodiment the data packets 64 comprise only dummy data. Alternatively the data packets 64 can also comprise information. This information contained in the data packets 64 does not need to be processed by the lighting device and can for example only be processed by the control unit of the power over Ethernet system. Alternatively also the lighting device 64 can process the information stored in the data packets.

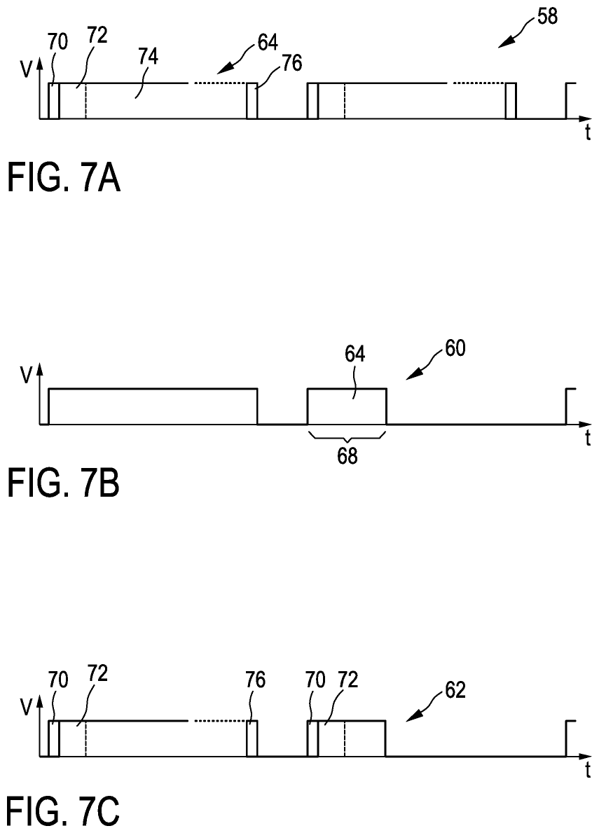

FIG. 7A, FIG. 7B and FIG. 7C show central data 58, local data 60, and processed data 62 in graphs with voltage V on the vertical axis and time t on the horizontal axis. The central data 58 is stored in the data packet 64. The local data 60 is encoded in a duration 68 of the data packet 64. Therefore the processed data comprises information encoded in the duration 68 of the data packet 64 as well as stored in the data packet 64, which allows encoding multiple control parameters, such as CCT and brightness. This embodiment regards encoded control data for controlling CCT and brightness of a LED of a lighting device 26 as presented in FIG. 5. The brightness is encoded in the local data 60 while CCT is encoded in the information stored in the data packet 64 of the central data 58. In other embodiments local data 60 can also be used to control for example both CCT and brightness.

FIG. 7A shows diagrammatically and exemplarily a simplified structure of an Ethernet data packet 64. The data packet 64 comprises an Ethernet frame that is used to store information for data transmission using the Ethernet protocol. The data packet 64 has a header 70 comprising a preamble, a start frame delimiter (SFD), a destination MAC address, a source MAC address, and an Ethertype. The data packet 64 furthermore has the data stored as payload 72, and a data fill field 74 comprising dummy data. The data packet 64 furthermore has a frame check sequence (FCS) 76.

The preamble consists of a 56-bit pattern of alternating 1 and 0 bits providing bit-level synchronization to allow devices connected via Ethernet connection to synchronize. The SFD marks a new incoming frame.

The destination MAC address is a unique address of a device that is meant to receive the data packet. The source MAC address is a unique address of a device which is the source of the data packet.

The Ethertype either defines the size of the payload 72 of the data packet 64 or it indicates that the data packet 64 is used as an Ethertype to indicate which protocol is encapsulated in the payload 72 of the data packet 64.

The payload 72 comprises the information to be transmitted from the source to the destination, e.g., data such as control data comprising a command. In this embodiment the payload 72 comprises CCT control data for controlling the CCT.

The data fill field 74 is used in order to add dummy data if the length of the data packet is below a minimal length. In this embodiment additional dummy data is filled in order to control the length and therefore duration of the data packets 64.

The FCS 76 is used in order to determine whether data transmitted in the data packet 64 is corrupted.

In contrast to the simple data transmission protocol the Ethernet protocol requires decoding the Ethernet data packet which inter alia requires decoding the MAC. This requires complex μC or μP. The simple data transmission protocol can be performed by simple logic units.

In this embodiment, however, a part of the information of the central data 58 is stored in the payload 72. Therefore the lighting device 26 comprises a complex μC that is able to decode the MAC.

FIG. 7B shows the local data 60 encoded in a duration 68 of the data packet 64. The duration 68 of data packets 64 can vary. Therefore data can be encoded in the duration of the data packets 64. The data packet 64 in FIG. 7A has a longer duration than the data packet 64 in FIG. 7B. The duration 68 in this embodiment is associated with a brightness of lighting device 26, such that a shorter duration leads to lower brightness and longer duration leads to higher brightness. In other embodiments the duration of the data packet can also be associated with any other data, such as control data, status data, or configuration data.

FIG. 7C shows processed data 62. The processed data 62 is generated based on the central data 58 and the local data 60. In this embodiment the data processing device has a toggling logic unit (not shown), which allows some data packets 64 of the central data 58 to pass through the data processing device without being processed, i.e., the local data 60 is generated in such a way that the central data 58 is not modified. Based on the full length data packets 64 the validity of the data can be verified using the FCS 76. Furthermore processed data 62 comprises shortened data packets based on the local data 60 that allow deriving the information of the local data 60 at the lighting device 26, e.g., the user input for the brightness setting.

FIG. 8 shows schematically and exemplarily a fifth embodiment of the data processing device 10″″ in a fifth embodiment of the power over Ethernet system 100″″. The fifth and fourth embodiments of the data processing device are similar. The only difference is that the data processing device 10″″ does not comprise ports. Instead the data communicating unit of the data processing device 10″″ is an Ethernet connection in form of a cable 12″ with two 8 position 8 contact (8P8C) connectors at each end of the cable 12″ for establishing a connection with a port 78 of PSE 24 and port 80 of lighting device 26. Hence the data processing device 10″″ in this embodiment is integrated in a cable. Any other suitable cable can be used for integrating the data processing device. Hence also other connectors can be arranged at the end of the cable.

FIG. 9 shows a first embodiment of a method for processing data in a power over Ethernet system. In step 200 central data transmitted from a PSE to a PD is intercepted. In step 210 local data is received from a local PD. The local data comprises user input data, sensing data, or user input data and sensing data. In step 220 the intercepted central data is processed in dependence of the local data. The processed data is transmitted to the PD in step 230. The steps 200 and 210 can also be interchanged.

The data, i.e., central data, local data, and processed data in this embodiment is encoded in a characteristic of one or more data packets. In particular the data is encoded in a number of data packets per time interval. In other embodiments the data can for example also be encoded in data packet length, data packet duration, number of data packets in a predetermined time interval, and/or sequence of data packets. In yet other embodiments the data can be encoded based on the Ethernet protocol, xClip protocol or any other protocol.

FIG. 10 shows a second embodiment of a method for processing data in a power over Ethernet system. The data is encoded in a number of data packets in a predetermined time interval, in this case 100 ms. In step 300 central data in form of control data comprising a command for controlling a brightness of a lighting device that is transmitted from a PSE to the lighting device is intercepted by capturing and counting data packets. In step 310 local data in form of brightness control values for the lighting device encoded in a number of data packets is received from a user interface device in form of a potentiometer. In step 320 the number of data packets of the central data is compared to the number of data packets of the local data. Furthermore processed data is generated in step 330 by generating a pulse width modulated signal that controls opening and closing of a simple switch. The switch is arranged in the line between the PSE and the lighting device. The pulse width modulated signal is transmitted to the simple switch for closing or opening it based on the comparison result. Therefore the number of data packets of the central data is reduced if the central data is transmitted along the line with the controlled simple switch in an open state. In a closed state the simple switch allows transmission of the data packets. Therefore the processed data is generated in step 330 by reducing the number of data packets of the central data transmitted to the lighting device. In step 340 the processed data is transmitted to the lighting device. The steps 300 and 310 can also be interchanged.

The embodiments of the method can be contained in a computer program comprising program code means. The program code means can cause a processor to carry out the embodiment of the method when the computer program is run on the processor.

While the invention has been illustrated and described in detail in the drawings and foregoing description, such illustration and description are to be considered illustrative or exemplary and not restrictive; the invention is not limited to the disclosed embodiments. For example, it is possible to operate the invention in an embodiment wherein a control system, in particular a remote control system, is used to control lighting devices in an Ethernet System. This allows to use a simple pulse width modulated output to manipulate an Ethernet data stream instead of adding full Ethernet capability to the control system.

Furthermore it is possible to operate the invention in an embodiment wherein data security is an important aspect. By using the method according to any embodiment of the invention, a second control system, in particular remote control system, can influence the data in a first control system without being able to actually receive the data. This allows to shield data comprising sensitive information and/or secret information shared over the first network such as addressing schemes, grouping rules, or any other sensitive or secret information shared over the first network, from the second control system.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit, processor, or device may fulfill the functions of several items recited in the claims. The mere fact that certain measures are recited in mutually different dependent claims does not indicate that a combination of these measures cannot be used to advantage.

Operations like intercepting data, receiving data, transmitting data, processing data, receiving encoded data, transmitting encoded data, encoding data, decoding data, performing a function based on the data, et cetera performed by one or several units or devices can be performed by any other number of units or devices. These operations and/or the control of the data processing device, PD, PSE, BMS, or power over Ethernet system can be implemented as program code means of a computer program and/or as dedicated hardware.

A computer program may be stored/distributed on a suitable medium, such as an optical storage medium, or a solid-state medium, supplied together with or as part of other hardware, but may also be distributed in other forms, such as via the Internet, Ethernet, or other wired or wireless telecommunication systems.

Any reference signs in the claims should not be construed as limiting the scope.

In summary the present invention relates to a data processing device for a power over Ethernet system. The data processing device comprises a data communicating unit and a data processing unit. The data communicating unit is configured for establishing a first connection to a power sourcing equipment and a second connection to a powered device and for intercepting central data transmitted from the power sourcing equipment to the powered device. The data processing unit is configured to process the intercepted central data in dependence of local data received from a local powered device. The local data comprises user input data, sensing data, or user input data and sensing data. The data communicating unit is furthermore configured for transmitting the processed data to the powered device. Hence local data can influence central data for improving local control.

1. A data processing device for a power over Ethernet system comprising
a data communicating unit for establishing a first connection to a power sourcing equipment and a second connection to a powered device, wherein the data communicating unit is configured for intercepting central data transmitted from the power sourcing equipment to the powered device, and
a data processing unit configured to process the intercepted central data in dependence of local data received from a local powered device, wherein the data communicating unit is configured for transmitting the processed data to the powered device, and wherein the local data comprises user input data, sensing data, or user input data and sensing data
a simple logic unit configured for encoding data in a characteristic of one or more data packets, decoding data encoded in a characteristic of one or more data packets, and/or processing data encoded in a characteristic of one or more data packets; wherein the characteristic comprises data packet length, data packet duration, number of data packets in a predetermined time interval, and/or sequence of data packets.

2. The data processing device according to claim 1, wherein the data processing unit is configured to determine the processed data by calculating a function depending on central data and local data.

3. The data processing device according to claim 1, wherein the data communicating unit is configured for intercepting data transmitted between the powered device and the power sourcing equipment.

4. The data processing device according to claim 1, wherein the simple logic unit comprises a switch, a logic gate, a comparator, a timer, and/or a counter.

5. The data processing device according to claim 1, wherein the simple logic unit is configured for processing the intercepted central data in dependence of the local data by reducing the length, duration and/or number of data packets of the central data.

6. The data processing device according to claim 1, wherein the data is encoded in a pulse-density modulation.

7. The data processing device according to claim 1, wherein the central data comprises control data comprising a command for controlling the powered device and wherein the processed data comprises control data comprising a command for controlling the powered device based on the central data and the local data.

8. A power over Ethernet system comprising
a data processing device according to claim 1,
a power sourcing equipment, and
a powered device, wherein the data processing device is daisy chained between the power sourcing equipment and the powered device.

9. The system according to claim 8, wherein the powered device comprises a functional unit configured for performing a function based on the processed data.

10. The system according to claim 8, wherein the power sourcing equipment and/or the powered device comprises a simple logic unit configured for encoding data in a characteristic of one or more data packets and/or for decoding data encoded in a characteristic of one or more data packets, and wherein the system is configured for transmitting the encoded data between the power sourcing equipment and the powered device.

11. The system according to claim 8, wherein the powered device is a lighting device, a user interface device, a sensor device, a magnet device, an actuator device, a fan device, a heating device, a cooling device, or a temperature regulating device.

12. A method for processing data in a power over Ethernet system comprising the steps:
intercepting central data transmitted from a power sourcing equipment to a powered device,
receiving local data from a local powered device, wherein the local data comprises user input data, sensing data, or user input data and sensing data,
processing the intercepted central data in dependence of the local data, and
transmitting the processed data to the powered device, wherein the method further comprising one or more of the steps of:
encoding data in a characteristic of one or more data packets,
decoding data encoded in a characteristic of one or more data packets,
processing data encoded in a characteristic of one or more data packets;
wherein the characteristic comprises data packet length, data packet duration, number of data packets in a predetermined time interval, and/or sequence of data packets.

13. A computer program for processing data in a power over Ethernet system, wherein the computer program comprises program code means for causing a processor to carry out the method as defined in claim 14, when the computer program is run on the processor.
